(19) United States
(12) Patent Application Publication
(10) Pub. No.: US 2007/0213036 A1
(43) Pub. Date: Sep. 13, 2007

(54) Portable system, portable apparatus, supporting apparatus, and control method thereof

(75) Inventor: Ho-jin Byun, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/698,840

(22) Filed: Jan. 29, 2007

(30) Foreign Application Priority Data
Mar. 10, 2006 (KR) 10-2006-0022749

(51) Int. Cl. H04Q 7/38; H04Q 7/22; H04M 3/42

(52) U.S. Cl. 455/414.1

(57) ABSTRACT

A portable system comprises a portable apparatus which performs a plurality of functions according to predetermined control information; and a supporting apparatus for the portable apparatus, the supporting apparatus comprising: a connecting part which is connectable to the portable apparatus; a storing part which stores the predetermined control information corresponding to the plurality of functions of the portable apparatus; and a controller which stores control information corresponding to a selected function among the plurality of functions in the storing part, and transmits the control information stored in the storing part to the portable apparatus for performing the selected function if the portable apparatus is connected to the connecting part.

### CROSS-REFERENCE TO RELATED APPLICATIONS

This application claims priority from Korean Patent Application No. 10-2006-0022749, filed on Mar. 10, 2006 in the Korean Intellectual Property Office, the disclosure of which is incorporated herein in its entirety by reference.

### BACKGROUND OF THE INVENTION

1. Field of the Invention

The present invention relates to a portable apparatus, a supporting apparatus, and a control method thereof, and more particularly, to a portable apparatus, a supporting apparatus, and a control method thereof capable of performing a function selected by a user among a variety of functions of the portable apparatus when the portable apparatus is connected to the supporting apparatus.

2. Description of the Related Art

A portable apparatus, such as a portable media player (PMP), a portable digital assistant (PDA), a digital multimedia broadcasting (DMB) player, an MPEG (Moving Picture Experts Group) audio layer-3 (MP3) player, an electronic dictionary, a cellular phone, and the like, is a compact means for a user to carry and use. Recently, the portable apparatus has more various functions such as a music player, a moving image player, a video-game machine, a digital camera, an electronic day planner, and the like.

The portable apparatus is operated by its portable battery as a power source. The portable apparatus is charged by being put in a supporting apparatus having a charging device, so-called a cradle. Also, the cradle may have a data communicating part for data-communicating with an external device such as a television (TV), a computer system, and the like, thereby allowing the portable apparatus to data-communicate with the external device.

Generally, it is often convenient that necessary functions of the portable apparatus are performed while the portable apparatus is put in the cradle. In this time, a user should allow the portable apparatus to perform the necessary functions by manipulating it before or after putting it in the cradle.

Accordingly, it may be quite a troublesome job that the user should manipulate the portable apparatus to perform the necessary functions whenever the user puts it in the cradle. Particularly, if there are specific functions that should be frequently performed, and further, if manipulations for performing the functions on the portable apparatus are complicated, it is a more troublesome job for the user.

### SUMMARY OF THE INVENTION

According to an aspect of the present invention, there is provided a portable system comprising: a portable apparatus which performs a plurality of functions according to predetermined control information; and a supporting apparatus comprising: a connecting part which is connectable to the portable apparatus; a storing part which stores the predetermined control information corresponding to the plurality of functions of the portable apparatus; and a controller which stores control information corresponding to a selected function among the plurality of functions in the storing part, and transmits the control information stored in the storing part to the portable apparatus for performing the selected function if the portable apparatus is connected to the connecting part.

According to another aspect of the present invention, the control information corresponds to the selected function which is selected before the portable apparatus is connected to the connecting part.

According to another aspect of the present invention, the control information corresponds to the selected function which is selected after the portable apparatus is connected to the connecting part.

According to another aspect of the present invention, while the portable apparatus performs the selected function, the controller transmits control information corresponding to another selected function among the plurality of functions to the portable apparatus.

According to another aspect of the present invention, the supporting apparatus further comprises a sound outputting part, and the controller controls the sound outputting part to process sound data transmitted from the portable apparatus.

According to another aspect of the present invention, the controller determines whether the portable apparatus is turned on or off.

According to another aspect of the present invention, the controller transmits a control signal corresponding to a turn-on state to the portable apparatus when the portable apparatus is turned off.

According to an aspect of the present invention, there is provided a portable apparatus comprising: a connecting part which is connectable to a supporting apparatus; a function performing part which performs a plurality of functions; a storing part which stores predetermined control information corresponding to the plurality of functions; and a controller which stores control information corresponding to a selected function among the plurality of functions in the storing part, and controls the function performing part to perform the selected function corresponding to the control information stored in the storing part if the supporting apparatus is connected to the connecting part.

According to another aspect of the present invention, while the function performing part performs the selected function, if another function among the plurality of functions is selected, the controller controls the function performing part to perform the other selected function.

According to an aspect of the present invention, there is provided a method of controlling a supporting apparatus which is connectable to a portable apparatus which performs at least one function among a plurality of functions comprising: selecting a function among the plurality of functions; storing control information corresponding to the selected function; and transmitting the control information to the portable apparatus for performing the selected function if the portable apparatus is connected to the supporting apparatus.

According to another aspect of the present invention, the selecting the function among the plurality of functions is performed before the portable apparatus is connected to the supporting apparatus.

According to another aspect of the present invention, the selecting the function among the plurality of functions is performed after the portable apparatus is connected to the supporting apparatus.

According to another aspect of the present invention, the method further comprises, while the portable apparatus performs the function, selecting another function among the plurality of functions; and transmitting control information corresponding to the other selected function to the portable apparatus.

According to another aspect of the present invention, the method further comprises outputting a sound based on sound data transmitted from the portable apparatus.

According to another aspect of the present invention, the method further comprises determining whether the portable apparatus is turned on or off.

According to another aspect of the present invention, the method further comprises transmitting a control signal corresponding to a turn-on state to the portable apparatus if the portable apparatus is turned off.

According to an aspect of the present invention, there is provided a method of controlling a portable apparatus which performs at least one function among a plurality of functions comprising: selecting a function among the plurality of functions; storing control information corresponding to the selected function; and performing the selected function corresponding to the control information if a supporting apparatus is connected to the portable apparatus.

According to another aspect of the present invention, the method further comprises, while the selected function is performed, selecting another function among the plurality of functions; and performing the other selected function.

### BRIEF DESCRIPTION OF THE DRAWINGS

The above and/or other aspects of the present invention will become apparent and more readily appreciated from the following description of exemplary embodiments, taken in conjunction with the accompanying drawings, in which:

FIG. 1 is a block diagram illustrating a configuration of a supporting apparatus according to a first exemplary embodiment of the present invention;

FIG. 2 is a block diagram illustrating a configuration of a portable apparatus according to a second exemplary embodiment of the present invention;

FIG. 3 is a diagram showing a menu screen appearing during a function selecting operation according to the first exemplary embodiment of the present invention;

FIG. 4 is a flowchart illustrating an operation of the supporting apparatus according to the first exemplary embodiment of the present invention; and

FIG. 5 is a flowchart illustrating an operation of the portable apparatus according to the second exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout.

The exemplary embodiments of the present invention will be described hereinafter with reference to the accompanying drawings.

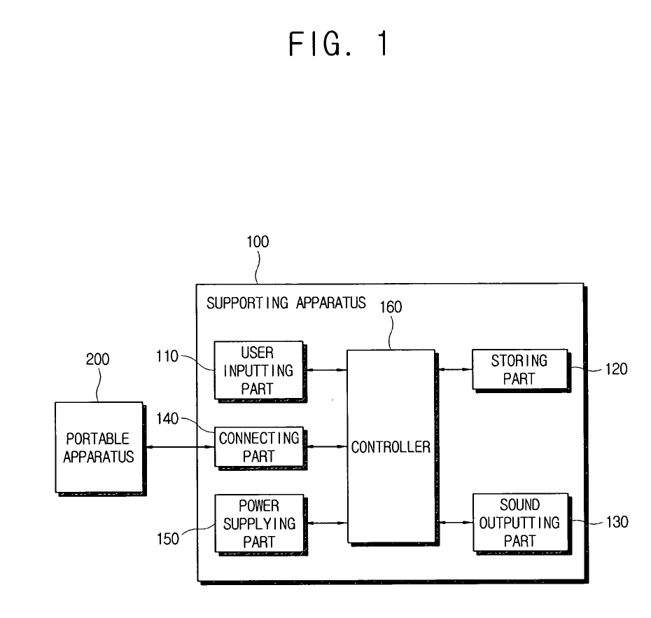

FIG. 1 is a block diagram illustrating a configuration of a supporting apparatus according to a first exemplary embodiment of the present invention. The supporting apparatus 100 supplies power to a portable apparatus 200 which is a compact means for a user to carry and use, and allows the portable apparatus 200 to data-communicate with an external device such as a TV, a computer system, and the like. The supporting apparatus 100 may be realized with a cradle of the portable apparatus 200.

Here, the portable apparatus 200 has at least one function among taking and displaying a picture, camcodering and replaying a moving image, replaying music, an electronic dictionary, an e-book, a car navigation, and the like. The portable apparatus 200 may be realized with a PMP, a PDA, a DMB player, an MP3 player, an electronic dictionary, a cellular phone, and the like.

As illustrated, the supporting apparatus 100 according to the first exemplary embodiment includes a user inputting part 110, a storing part 120, a sound outputting part 130, a connecting part 140, a power supplying part 150, and a controller 160.

A user inputs a predetermined instruction to the user inputting part 110. The user inputting part 110 transmits the instruction to the controller 160. Through the user inputting part 110, the user selects one function among a plurality of functions of the portable apparatus 200.

The storing part 120 stores control information corresponding to the plurality of functions of the portable apparatus 200. Under control of the controller 160, the storing part 120 stores the control information on a function selected by the user.

The sound outputting part 130 outputs a sound under control of the controller 160. Under control of the controller 160, the sound outputting part 130 converts and processes sound data transmitted from the portable apparatus 200, thereby outputting them in a sound volume. Herein, the sound outputting part 130 may include a speaker.

The connecting part 140 is connected to the portable apparatus 200, thereby supplying a predetermined power provided by the power supplying part 150 to the portable apparatus 200. Herein, the connecting part 140 includes a power supplying port. Under control of the controller 160, the connecting part 140 transmits a control signal to the portable apparatus 200. Herein, the connecting part 140 includes a communicating port.

The power supplying part 150, which is supplied a power from an external means, provides a suitable power for charging the portable battery of the portable apparatus 200 through the connecting part 140.

The controller 160 generally controls operations of the user inputting part 110, the storing part 120, a sound outputting part 130, the connecting part 140, and the power supplying part 150.

When a user selects any one among the plurality of functions of the portable apparatus 200 through the user inputting part 110, the controller 160 allows information corresponding to the selected function to be stored in the storing part 120.

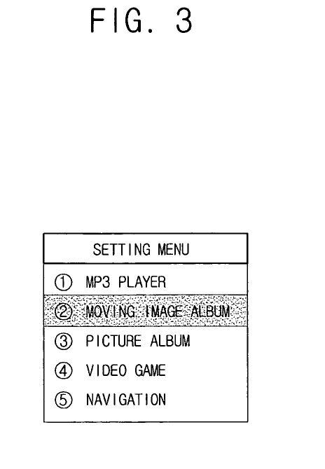

FIG. 3 is a diagram showing a menu screen that appears during a function selecting operation according to the first exemplary embodiment of the present invention. If a menu selecting signal is input from the user inputting part 110, as illustrated, the controller 160 provides a user to the menu screen as a graphic user interface (GUI).

According to a user's manipulation by upward/downward moving buttons or a selecting button provided on the user inputting part 110, the controller 160 may select a function among a MP3 player, a moving image album, a picture album, a video game, a navigation, etc.

The controller 160 determines whether the portable apparatus 200 is connected to the connecting part 140. Herein, the controller 160 includes a predetermined port for sensing whether the portable apparatus 200 is connected to the connecting part 140. If the portable apparatus 200 is connected to the connecting part 140, a logical high signal is input to the predetermined port. Conversely, if the portable apparatus 200 is not connected to the connecting part 140, a logical low signal is input to the predetermined port. Accordingly, it is determined whether the portable apparatus 200 is connected to the connecting part 140.

The controller 160 determines whether the portable apparatus 200 is turned on or off. If the controller 160 determines that the portable apparatus 200 is turned off, the controller 160 transmits a control signal corresponding to a turn-on state to the portable apparatus 200. Here, the controller 160 transmits the signal for requesting a response to the connecting part 140. Then, the controller 160 determines whether a return of the signal for the response is received from the portable apparatus 200 within a predetermined time, thereby determining whether the portable apparatus 200 is turned on or off.

If the portable apparatus 200 is turned on, the controller 160 transmits control information corresponding to a function of the portable apparatus 200 selected by a user, which is stored in the storing part 120, to the portable apparatus 200.

At this time, if the selected function of the portable apparatus 200 is to output a sound, the controller 160 transmits a control signal for requesting sound data to be output to the portable apparatus 200. The controller 160 receives the sound data from the portable apparatus 200 and controls the sound outputting part 130 to convert the sound data transmitted from the portable apparatus 200 into suitable sound data for output.

The controller 160 transmits control information corresponding to a selected function of the portable apparatus 200 to the portable apparatus 200. Accordingly, while the portable apparatus 200 performs the selected function, if the controller 160 receives a signal for selecting another function among the plurality of functions of the portable apparatus 200, the controller 160 transmits a control signal corresponding to the newly-selected function to the portable apparatus 200.

To perform above-mentioned operations, the controller 160 may be realized as such a type that the controller 160 is programmed by software suitable for a predetermined general processor, and the controller is controlled by the general processor. Here, the software is stored in a predetermined memory, for example, a read only memory (ROM).

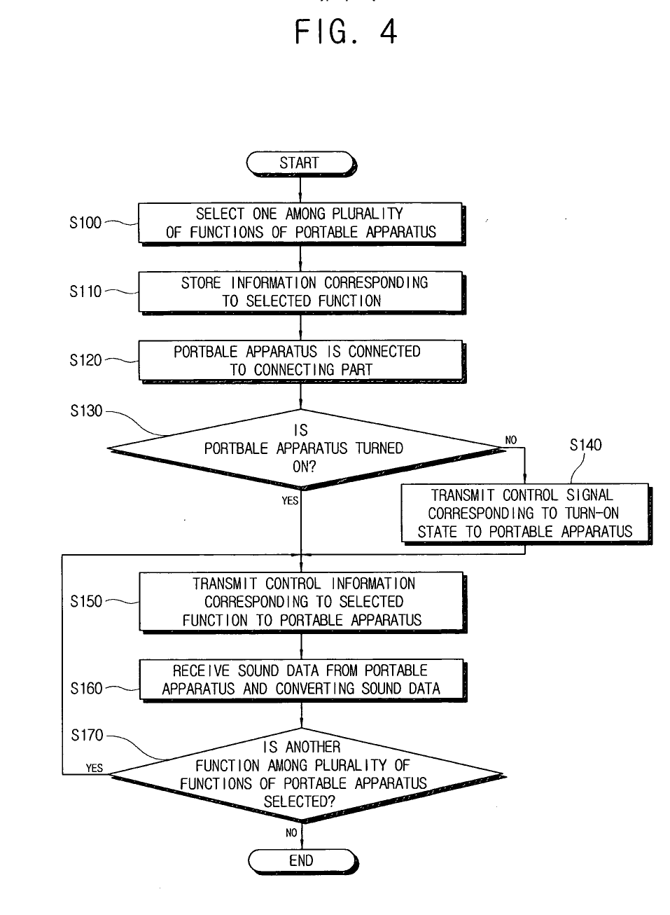

FIG. 4 is a flowchart illustrating an operation of the supporting apparatus according to the first exemplary embodiment of the present invention. The operation of the supporting apparatus according to the first exemplary embodiment of the present invention will be in detail described with reference to FIG. 4.

A user inputs one function among a plurality of functions of the portable apparatus 200 to the controller 160 through the user inputting part 110 (S100). Then, information corresponding to the selected function is stored (S110). When the portable apparatus 200 is put in the supporting apparatus 100, if the controller 160 senses that the portable apparatus 200 is connected to the connecting part 140 (S120), the controller 160 determines whether the portable apparatus 200 is turned on or off (S130).

In the operation S130, if the controller 160 determines that the portable apparatus 200 is turned off, the controller 160 transmits a control signal corresponding to a turn-on state to the portable apparatus 200 (S140), thereby turning the portable apparatus 200 on.

If the controller 160 determines that the portable apparatus 200 is turned on, the controller 160 transmits a control information corresponding to a function of the portable apparatus 200 selected by a user, which is stored in the storing part 120, to the portable apparatus 200 (S150).

The controller 160 transmits a control signal for requesting sound data to be output to the portable apparatus 200. The controller 160 receives the sound data from the portable apparatus 200 and controls the sound outputting part 130 to convert the sound data transmitted from the portable apparatus 200 into suitable sound data for output (S160). In the first exemplary embodiment of the present invention, the selected function of the portable apparatus 200 is for outputting a sound. However, if the selected function of the portable apparatus 200 is not for outputting the sound, it is possible to omit the operation S160.

While the controller 160 transmits the control information corresponding to the function selected in the operation S100, and the portable apparatus 200 performs the selected function, if a signal for selecting another function among the plurality of functions of the portable apparatus 200 is received (S170), the controller 160 transmits a control signal corresponding to the newly-selected function to the portable apparatus 200.

The first exemplary embodiment of the present invention has been described by employing the case that after a function of the portable apparatus 200 is selected in the supporting apparatus 100, the portable apparatus 200 comes to be connected to the connecting part 140. In the case that after the portable apparatus 200 is connected to the connecting part 140, a function of the portable apparatus 200 comes to be selected in the supporting apparatus 100, sequent operations are also the same as the above-mentioned operations S130 through S170 as shown in FIG. 4.

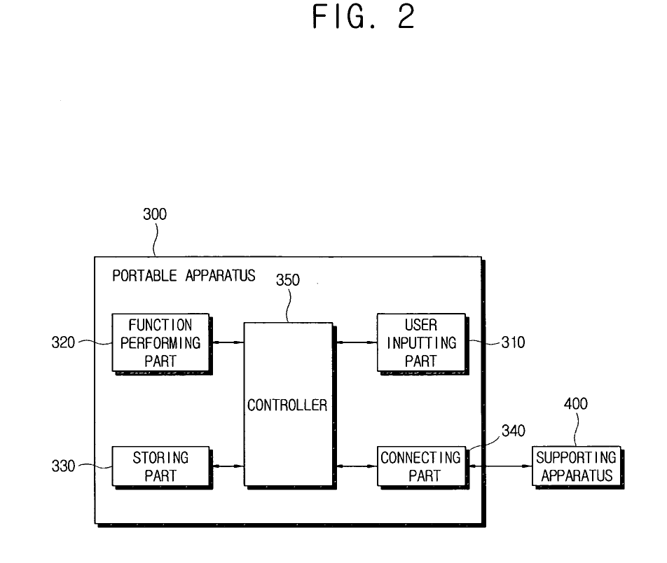

FIG. 2 is a block diagram illustrating a configuration of a portable apparatus according to a second exemplary embodiment of the present invention.

The portable apparatus 300 has at least one function among taking and displaying a picture, camcodering and replaying a moving image, music replaying, an electronic dictionary, an e-book, a car navigation, and the like. The portable apparatus 300 may be realized with a PMP, a PDA, a DMB player, an MP3 player, an electronic dictionary, a cellular phone, and the like.

The supporting apparatus 400 according to the second exemplary embodiment may be realized with a cradle of the portable apparatus 300.

As illustrated, the portable apparatus 300 according to the second exemplary embodiment includes a user inputting part 310, a function performing part 320, a storing part 330, a connecting part 340, and a controller 350.

A user inputs a predetermined instruction to the user inputting part 310. The user inputting part 310 transmits the instruction to the controller 350. Through the user inputting part 310, the user selects one function among a plurality of functions of the portable apparatus 300.

The function performing part 320 performs a plurality of functions of the portable apparatus 300 under control of the controller 350. The function performing part 320 may perform at least one function among taking and displaying a picture, camcodering and replaying a moving image, replaying music, an electronic dictionary, an e-book, a car navigation, and the like.

The storing part 330 stores control information on a function selected by the user among the plurality of functions of the portable apparatus 300 under control of the controller 350.

The connecting part 340 is connected to the supporting apparatus 400, thereby being provided a predetermined power and supplying the power to a portable battery (not shown) of the portable apparatus 300. Herein, the connecting part 340 includes a power supplying port for this operation above.

The controller 350 generally controls operations of the user inputting part 310, the function performing part 320, the storing part 330, and the connecting part 340.

When a user selects any one among the plurality of functions of the portable apparatus 300 through the user inputting part 310, the controller 350 allows information corresponding to the selected function to be stored in the storing part 330.

The controller 350 determines whether the supporting apparatus 400 is connected to the connecting part 340. Herein, the controller 350 includes a predetermined port for sensing whether the supporting apparatus 400 is connected to the connecting part 340. If the supporting apparatus 400 is connected to the connecting part 340, a logical high signal is input to the predetermined port. Conversely, if the supporting apparatus 400 is not connected to the connecting part 340, a logical low signal is input to the predetermined port. Thus, it can be determined whether the supporting apparatus 400 is connected to the connecting part 340.

If the controller 350 determines that the supporting apparatus 400 is connected to the connecting part 340, the controller 350 controls the function performing part 320 so that a function of the portable apparatus 300 selected by a user, which is stored in the storing part 330, can be performed.

While the portable apparatus 300 performs the previous-selected function, if a signal for selecting another function among the plurality of functions of the portable apparatus 300 is received through the user inputting part 310, the controller 350 controls the function performing part 320 so that the newly-selected function can be performed.

To perform above-mentioned operations, the controller 350 may be realized as such a type that the controller 350 is programmed by software suitable for a predetermined general processor, and controlled by the general processor. Here, the software is stored in a predetermined memory, for example, a ROM.

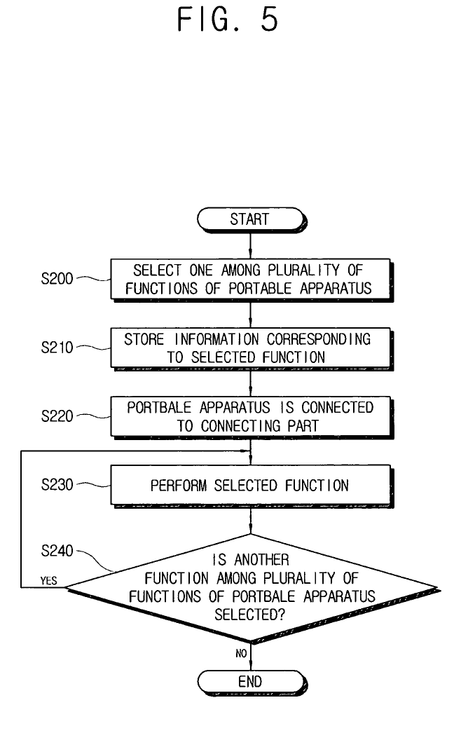

FIG. 5 is a flowchart illustrating an operation of the portable apparatus according to the second exemplary embodiment of the present invention.

A user inputs one among a plurality of functions of the portable apparatus 300 to the controller 350 through the user inputting part 310 (S200). Then, information corresponding to the selected function is stored (S210).

When the portable apparatus 300 is put in the supporting apparatus 400, if the controller 350 senses that the supporting apparatus 400 is connected to the connecting part 340 (S220), the controller 350 controls the function performing part 320 so that a function of the portable apparatus 300 selected by a user, which is stored in the storing part 330, can be performed (S230).

While the portable apparatus 300 performs the previous-selected function, if a signal for selecting another function among the plurality of functions of the portable apparatus 300 is received through the user inputting part 310 (S240), the controller 350 controls the function performing part 320 so that the newly-selected function can be performed.

Accordingly, it is possible that a function selected by a user among a variety of functions of the portable apparatus is performed when the portable apparatus is connected to the supporting apparatus.

As described above, according to the exemplary embodiments of the present invention, it is possible to reduce troublesome jobs to manipulate a button for performing a specific function on the portable apparatus by allowing a function selected by a user among a variety of functions of the portable apparatus to be performed when the portable apparatus is connected to a cradle.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A portable system comprising:
a portable apparatus which performs a plurality of functions according to predetermined control information; and
a supporting apparatus comprising:
a connecting part which is connectable to the portable apparatus;
a storing part which stores the predetermined control information corresponding to the plurality of functions of the portable apparatus; and
a controller which stores control information corresponding to a selected function among the plurality of functions in the storing part, and transmits the control information stored in the storing part to the portable apparatus for performing the selected function if the portable apparatus is connected to the connecting part.

2. The portable system according to claim 1, wherein the control information corresponds to the selected function which is selected before the portable apparatus is connected to the connecting part.

3. The portable system according to claim 1, wherein the control information corresponds to the selected function which is selected after the portable apparatus is connected to the connecting part.

4. The portable system according to claim 1, wherein while the portable apparatus performs the selected function, the controller transmits control information corresponding to another selected function among the plurality of functions to the portable apparatus.

5. The portable system according to claim 1, wherein the supporting apparatus further comprises a sound outputting part, and the controller controls the sound outputting part to process sound data transmitted from the portable apparatus.

6. The portable system according to claim 1, wherein the controller determines whether the portable apparatus is turned on or off.

7. The portable system according to claim 6, wherein the controller transmits a control signal corresponding to a turn-on state to the portable apparatus when the portable apparatus is turned off.

8. A portable apparatus comprising:
a connecting part which is connectable to a supporting apparatus;
a function performing part which performs a plurality of functions;
a storing part which stores predetermined control information corresponding to the plurality of functions; and
a controller which stores control information corresponding to a selected function among the plurality of functions in the storing part, and controls the function performing part to perform the selected function corresponding to the control information stored in the storing part if the supporting apparatus is connected to the connecting part.

9. The portable apparatus according to claim 8, wherein while the function performing part performs the selected function, if another function among the plurality of functions is selected, the controller controls the function performing part to perform the other selected function.

10. A method of controlling a supporting apparatus which is connectable to a portable apparatus which performs at least one function among a plurality of functions comprising:
selecting a function among the plurality of functions;
storing control information corresponding to the selected function; and
transmitting the control information to the portable apparatus for performing the selected function if the portable apparatus is connected to the supporting apparatus.

11. The method according to claim 10, wherein the selecting the function among the plurality of functions is performed before the portable apparatus is connected to the supporting apparatus.

12. The method according to claim 10, wherein the selecting the function among the plurality of functions is performed after the portable apparatus is connected to the supporting apparatus.

13. The method according to claim 10, further comprising:
while the portable apparatus performs the selected function, selecting another function among the plurality of functions; and
transmitting control information corresponding to the other selected function to the portable apparatus.

14. The method according to claim 10, further comprising:
outputting a sound based on sound data transmitted from the portable apparatus.

15. The method according to claim 10, further comprising:
determining whether the portable apparatus is turned on or off.

16. The method according to claim 15, further comprising:
transmitting a control signal corresponding to a turn-on state to the portable apparatus if the portable apparatus is turned off.

17. A method of controlling a portable apparatus which performs at least one function among a plurality of functions comprising:
selecting a function among the plurality of functions;
storing control information corresponding to the selected function; and
performing the selected function corresponding to the control information if a supporting apparatus is connected to the portable apparatus.

18. The method according to claim 17, further comprising:
while the selected function is performed, selecting another function among the plurality of functions; and
performing the other selected function.
